(19) United States
(12) Patent Application Publication
(10) Pub. No.: US 2003/0066048 A1
(43) Pub. Date: Apr. 3, 2003

(54) Computer controlled display system for controlling and tracking of software program objects through a displayed sequence of build events and enabling user registration to perform actions on said build events

(75) Inventors: David Bruce Kumhyr, Austin, TX (US); Jacob Zachariah, Austin, TX (US)

Correspondence Address: Leslie A. Van Leeuwen, International Business Machines Corporation, Intl Prop Law Dept., Internal Zip 4054, 11400 Burnet Road, Austin, TX, 78758, US

(73) Assignee: International Business Machines Corporation, Armonk, NY

(21) Appl. No.: 09/966,005

(22) Filed: Sep. 28, 2001

(51) Int. Cl. G06F 9/44

(52) U.S. Cl. 717/101

(57) ABSTRACT

A computer display interface for dynamically tracking and enabling all of the contributing users to the development and building of software program objects and the events therein to quickly and easily view all aspects of the overall development and build, as well as the details of any specific event in any build object. It also permits the user to request for modifications in his actions, responsibilities and interests program objects and events. The combination of tracking each of a plurality of sets of sequential build events, each set of sequential build events respectively building a program object, displaying each of said sets of sequential build events and a selectively accessed dialog window associated with each of said displayed sequential build events enabling a user to interactively register or unregister to perform an action on said build event. There may also be available in the dialog window, an interactive menu of actions which the user may selectively perform on the associated build event at the current state of the event.

### CROSS-REFERENCE TO RELATED COPENDING PATENT APPLICATIONS

The following patent application, which is assigned to the assignee of the present invention and filed concurrently herewith, covers subject matter related to the subject matter of the present invention: A COMPUTER CONTROLLED DISPLAY SYSTEM FOR TRACKING THE DEVELOPMENT OF SOFTWARE PRODUCTS HAVING A PLURALITY OF DEVELOPMENT LINES THROUGH THE MONITORING OF SEQUENCES OF CHECKPOINTS RESPECTIVELY IN SAID LINES, Arnold J. Daks et al. (Attorney Docket No. AUS9-2001-0767).

### TECHNICAL FIELD

The present invention relates to distributed programming for computer software product development and particularly to the monitoring of the progress of product development distributed between a plurality of developmental lines in the development of computer software products.

### BACKGROUND OF RELATED ART

The last decade has been marked by a technological revolution driven by the convergence of the data processing and consumer electronics industries together with the explosion of the World Wide Web (Web) or Internet. As a result, extraordinary worldwide communication channels and resources have become available to businesses, and this has forever changed how many businesses and industries develop products, as well as the time cycles of such product development.

Nowhere are these dramatic changes in product development more apparent than in the development, testing and eventual production of computer software products. Over its first forty years prior to the 1980's, the software development environment was one in which an individual or a small dedicated group willing to put in long hard hours could create “elegant” software or “killer applications” directed to and effective in one or more of the limited computer system environments existing at the time.

Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not incompatible with, each newly developed computer software product, the development cycles have become very complex. Even when the software product development is an upgrade of an existing product, every addition, subtraction or modification of the program could have an insignificant or a profound effect on another operating system or application program that must be supported.

During the evolution of the software industries over the past two decades it has been evident that developing software will be combined in new, often unforeseen, ways, and, thus, there is an increased likelihood that the individual developments will drive systems programs that must be supported into inoperable states for certain purposes or under certain conditions. This changed development environment has caused many traditional and responsible software development houses to take the time and make the effort to resolve all potential incompatibilities with all existing and standard software before the new developed software products were commercially released. Unfortunately, the computer industry landscape is littered with the “corpses” of such responsible longer development cycle software houses which lost out to newer software product entrepreneurs that rushed to the market with unresolved incompatibilities. This, in turn, led to a distrust of new software products by consumers and businesses, i.e. a new software product will lead to down time until incompatibilities are resolved.

Accordingly, the computer software development industries have been working over the past several years toward the goal of the shortest development cycles with the fewest incompatibilities with standard existing software. One widely used approach to shortening software development cycle times has been to break down or distribute the development of complex software products into a plurality of development lines. This has been implemented in cooperative programming systems wherein program developers could coact to continuously develop, build and expand programs in a distributed program building environment. This distributed program building environment has both fueled and then been driven by the rise of object oriented programming. With its potentially interchangeable objects or units within which both data attributes and functions are stored in a predefined uniform framework, as well as the predefined object interfaces with each other, object-oriented programming systems offer ideal procedures for the rapid development and building of complex production-quality software program products through distributed build functions.

The technologies and problems involved in developing, building and bringing object oriented program products to market in short time cycles by distributing the development and build processes are described in detail in the text, Object Technology in Application Development, Daniel Tkach and Richard Puttick, International Business Machines Corporation, Addison-Wesley Publishing, Menlo Park, Calif., 1996.

In such a distributed program product development and build system with at least dozens of program developers and users continually dynamically making changes in the program objects or in the events which make up the objects, every addition, subtraction or modification of any event or object in the building of the program could have an insignificant or a profound effect on the program.

Of course all current development and build systems are set up with program development and build managers with whom all modifications have to be communicated and approved, and there are databases that keep track of the development and building of each program object and the events that comprise the object, as well as the modifications. However, current processes through which any interested user may access such data are still relatively cumbersome and time consuming.

### SUMMARY OF THE PRESENT INVENTION

The present invention provides a computer display interface for dynamically tracking and enabling all of the contributing users to the development and building of software program objects and the events therein to quickly and easily view all aspects of the overall development and build, as well as the details of any specific event in any build object. It also permits the user to request for modifications in his actions and responsibilities in program objects and events.

Accordingly, the invention provides for the combination of means for tracking each of a plurality of sets of sequential build events, each set of sequential build events respectively building a program object, means for displaying each of said sets of sequential build events, means associated with each of said displayed sequential build events enabling a user to interactively register to perform an action on said build event; and means associated with each of said displayed sequential build events enabling a user to interactively unregister to perform an action on said build event. Where the user has requested to register or unregister to perform an action on a build event, the invention further provides means for determining whether the user is authorized to perform or to unregister from performing said action.

The invention is preferably implemented by enabling a user to selectively request, e.g. by clicking on a displayed button, a displayed data entry dialog box through which the user may request registration or unregistration with respect to a specific action to be performed on an event in the build process; and means for determining from the data entered in said box whether the user is authorized to, thus, register or unregister. The action that the user registers to perform may be performed automatically in response to a triggering state in an object build event, or the user may be registered to be notified, e.g. even by e-mail of this state, and then be registered to selectively perform actions which can then be selected to be performed in response to his notification.

In accordance with a further aspect of this invention, the dialog box or window is associated with a build event in one of the program object builds. Such a dialog window may then provide to the user who clicks for the window a menu of actions that the user may selectively perform on the associated build event at the current state of the event together with data entry means enabling the user to request registration to perform an action on the build event or unregistration to perform an action on the build event.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as users' computer controlled display stations on which the display system of the present invention may be interactively accessed;

FIG. 2 is a diagrammatic view of a display screen on a computer station monitoring and controlling a plurality of object build lines;

FIG. 3 is the view of FIG. 2 after a user has brought up a dialog window associated with one of the build events;

FIG. 4 is an illustrative flowchart describing the setting up of the process of the present invention for the monitoring and control of a plurality of program object build lines in a complex program product build; and

FIG. 5 is a flowchart of an illustrative run of the process setup in FIG. 4.

### DETAILED DESCRIPTION OF THE PREFERRED EMBODIMENT

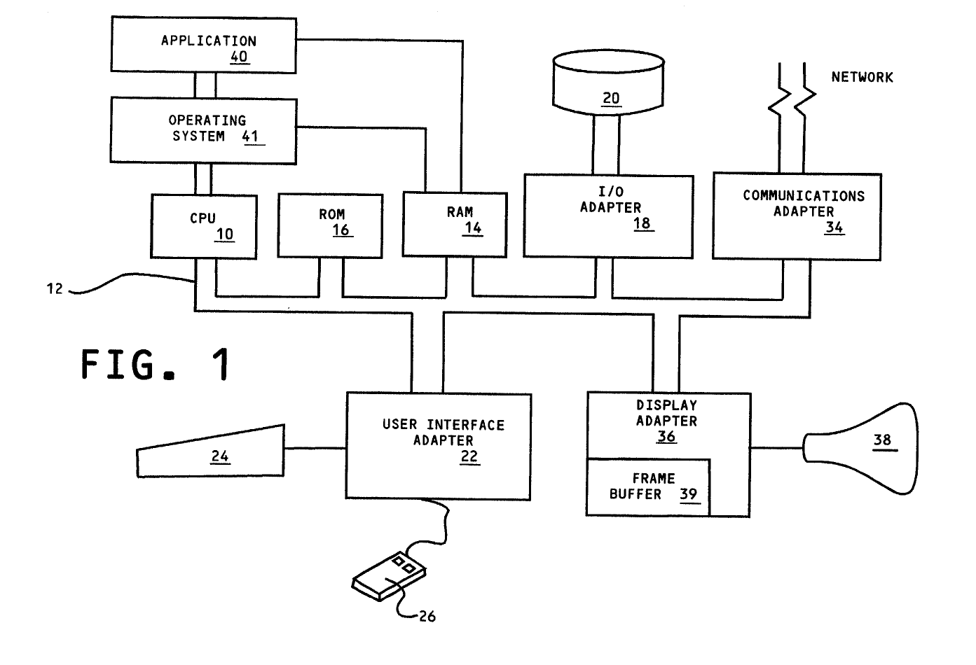

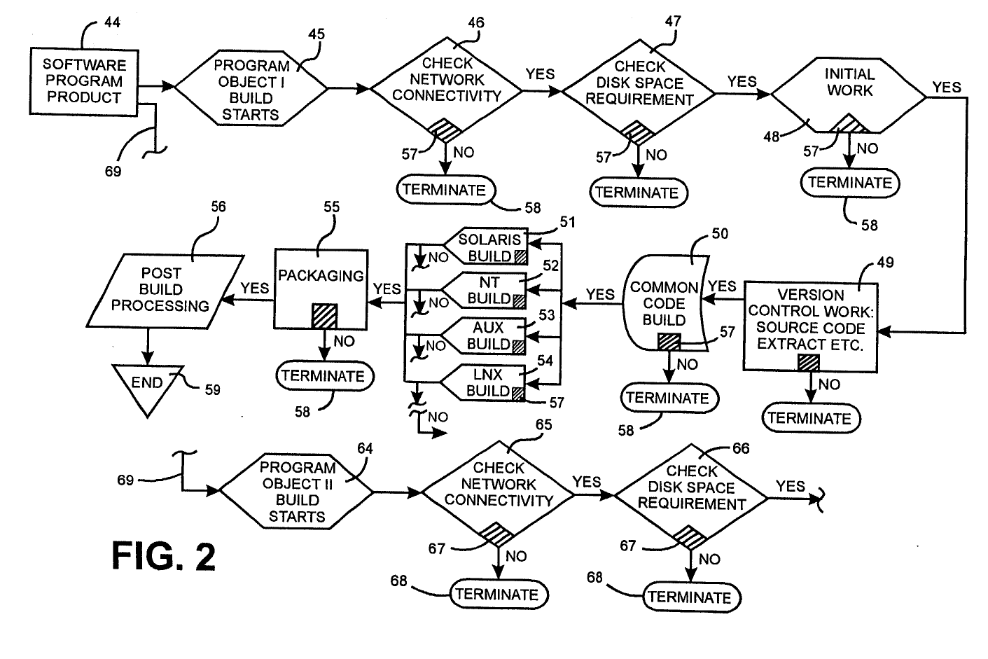

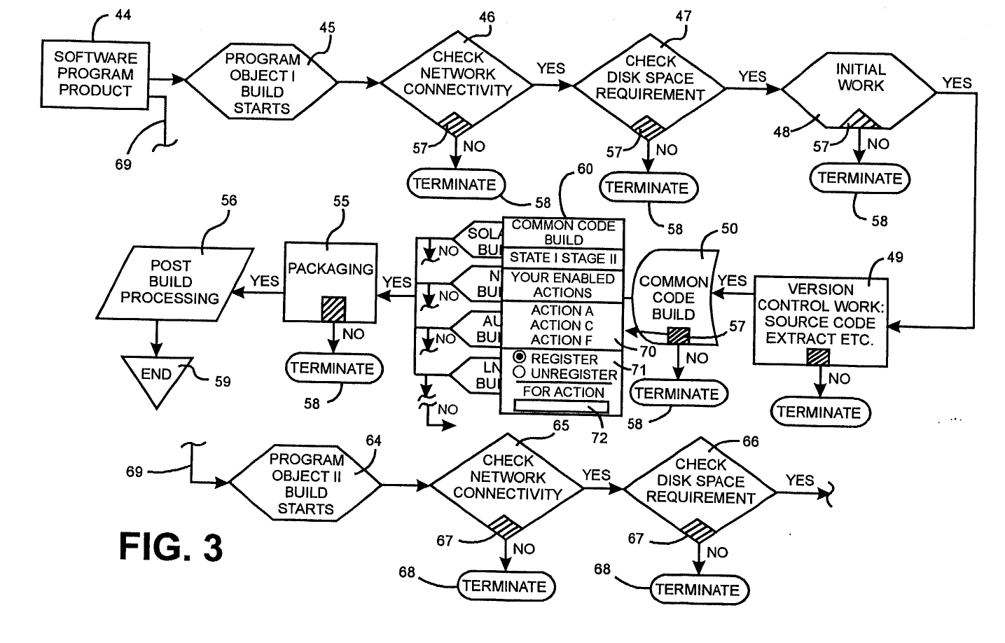

Before FIGS. 2 and 3, related to the overall tracking and control of the build lines, are described in detail, reference is made to FIG. 1 which represents a typical data processing display terminal that may function as the computer controlled display stations for tracking and controlling the progress on the developmental lines. A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX operating system available from IBM; Microsoft's WindowsMe™ or Windows 2000™, as well as various other UNIX and Linux operating systems. Application programs 40, controlled by the system, are moved into and out of the main memory Random Access Memory (RAM) 14. These programs include the programs of the present invention for the tracking and control of work progress on the various lines for building program objects to be described hereinafter in greater detail with respect to FIGS. 2 and 3. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over a Local Area Network (LAN) or a Wide Area Network (WAN), which includes the Web or Internet. I/O devices are also connected to system bus 12 via user interface adapter 22 and display adapter 36. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Referring now to FIG. 2, there is shown a diagrammatic view of a display screen on a computer station monitoring build lines for tracking and control of the plurality of build lines. The present invention relates to monitoring of the progress of program product object builds distributed between a plurality of build lines in the development of complex computer software products so that the data relative to each line is readily available and communicated to the users working on the lines. The present invention may be used to monitor and control several program product builds or development lines. In the present example, because of space limitations, we will show just one line and a portion of another: software program product 44 has an illustrative Program Object I Build Start 45 and a portion of another line 69 to Program Object II Build Start 64. Assume that Program Product 44 is at a build stage in a development-build production cycle as described in the Build/Testing stage in the above-referenced text, Object Technology in Application Development, pp. 7-11; this stage would normally follow the analysis/design and the implement/produce stages in program product development. It should be understood that while the illustrative embodiment of FIG. 2 relates to the build stage of program product development, the illustrated principles of the present invention are applicable to the other developmental stages. Thus, the program product may be made up of many Program Objects I, II . . . n. At the Build Start 45 or 64, the development build team controlled by an appropriate object build manager determines the various responsibilities of the members or users of the team, and each team user is designated one or more responsibilities or actions to be performed with respect to one or more of the events that will result in the building of the program objects. With the authorization of the object and/or event manager, the users are registered to perform these actions. These actions are usually performed in response to the occurrence of predetermined states in the flow of the object or event builds. The registered actions may be automatically performed by the system in response to triggering states, or the registered user may be informed of a state and then be enabled to selectively perform a responsive action.

Thus, as the object build commences and proceeds, all of the interested users may monitor and control the build process through access to a display screen as shown in FIG. 2. The building of Object I includes the following events: Check Network Connectivity 46; Check Disk Space Requirement 47; Initial Work 48; Version Control Work: Source Code Extract, etc., 49; Common Code Build 50; and then the following builds in which compatibility with conventional operating systems is ensured: Solaris Build 51, NT Build 52, AIX Build 53, and LNX Build 54. These events are then followed by a Packaging event 55 and a Post Build Processing event 56. The successful completion of an event is indicated by a Yes and a failure is indicated by a No that results in the termination 58 of the event. The complete successful build of Program Object I is indicated at End 59 (FIG. 2). The build line for Object II is partially represented by events Check Network Conductivity 65 and Check Disk Space Requirement 66, as well as Terminations 68. The user may monitor and get details of the state of any event and his responsibilities for that event by mouse-clicking the associated button 57 or 67. Such a button selection results in a window 60 for the selected event, which, as shown in FIG. 3, is Common Code Build event 50. The window may indicate the state of the event, e.g. “Build Stop”, or it may even indicate the state of a related event if that related event may require an action by the user. The user is also presented with a menu 70 of options, i.e. actions that are enabled to be performed at that time and stage. In the example shown, the condition of the Common Code Build is Stop. Because, as it turns out in this example, the stop is due to no connectivity to needed resources. The three options available to the user are: Retry Network, Restart or Cancel. In another state, the Common Code Build could have been in a running state where the only option on a menu would have been to Stop. Alternately, in another example, the state of the build could have been Stopped—due to a lack of storage space. In such a case, the options on the menu would have been: allocate storage, restart or cancel. The user is also given a dialog box 71 through which he may register to perform a particular action or unregister from an action that he has been assigned or previously requested to perform.

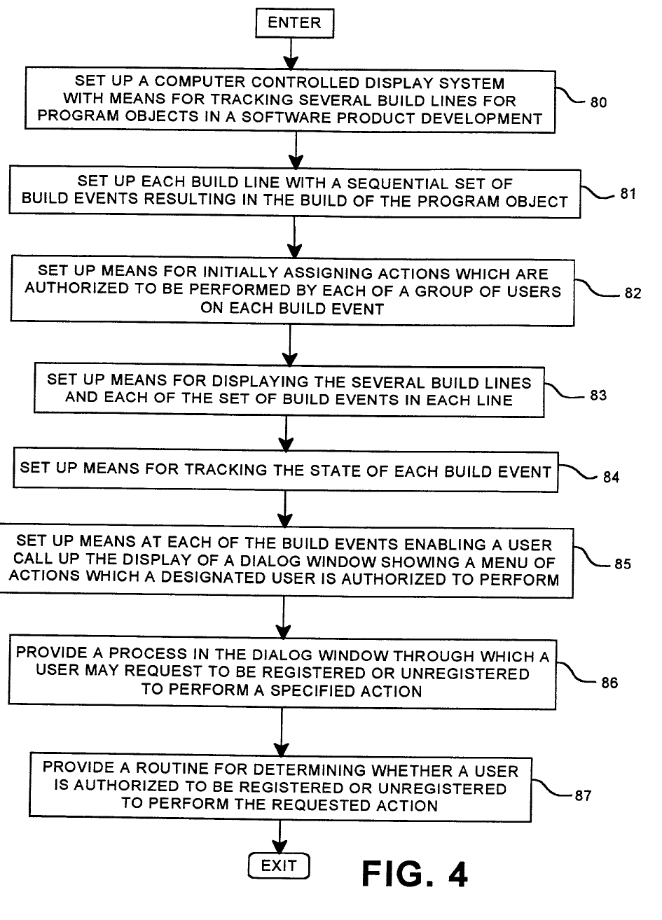

Now, with reference to FIG. 4, there will be described the setting up of a program according to the present invention for the tracking and control of work progress on the various program object build lines. There is set up a computer controlled display system with means for tracking several build lines for build objects in a software product development, step 80. There is set up a sequence of build events in each of the program object build lines, step 81. A process is set up for initially assigning which are authorized to be performed by each of a team of users on each build event, step 82. Means are provided for displaying sets of several build events in each of several build lines, step 83. A process for tracking the state of each build event, step 84 is set up. There is set up at each of the build events, means enabling a user to call up the display of a dialog window showing a menu of actions that a designated user is authorized to perform, step 85. A process in the dialog window through which a user may request to be registered or unregistered to perform a specific action is provided, step 86. A routine is provided, step 87, for determining whether a user is authorized to be registered or unregistered to perform the action requested in step 86.

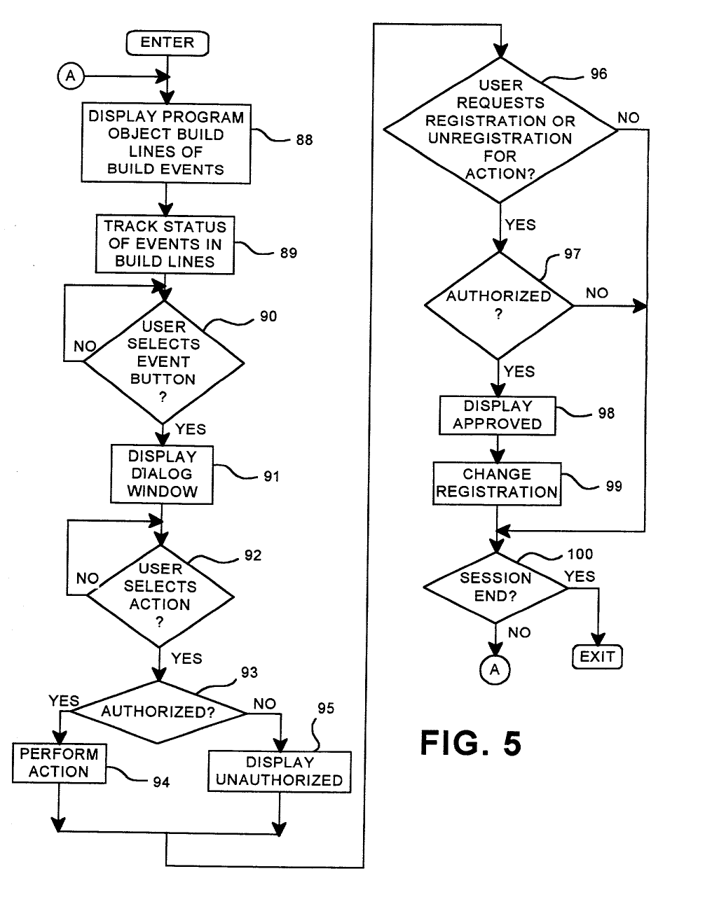

Now that the basic program set up has been described, there will be described with respect to FIG. 5 a flowchart of a simple operation showing how the program could be run. The display of FIG. 2 showing the object build lines of build events being monitored is displayed on the previously described display stations or terminals, step 88. The status of the events in the build lines is tracked, step 89. At any point, determinations are being made as to whether a user has selected a button 57 for the status of any build event, step 90. If No, the display continues and the selection of a button is awaited. If Yes, a button associated with one of the build events is selected, then a dialog window is displayed for the selected event, step 91. The dialog window provides the user with a menu of actions that he is authorized to take, and a determination is then made as to whether the user has selected one of the actions, step 92. If No, a selection is awaited. If Yes, then a further determination is made as to whether the selected action is still authorized for the user to perform, step 93. If No, the user is, thus, advised, step 95. If Yes, the action is performed, step 94. At this point, a further determination may be made as to whether the user has requested to be registered or unregistered for any action to be performed, step 97. If Yes, a determination is made as to whether the request is approved, step 96. If Yes, the registration or unregistration is displayed as approved, step 98, and the requested registration change is made, step 99. At this point, or if the decisions from steps 96 and 97 had been No, a determination may conveniently be made, step 100, as to whether the display session is at an end. If Yes, it is exited. If No, the process is returned to step 88 via branch “A” where the display with its current object and event build stage is available to its users.

One of the preferred implementations of the present invention is in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled user interactive display system for dynamically tracking and controlling the building of software program objects comprising:
means for tracking each of a plurality of sets of sequential build events, each set of sequential build events respectively building a program object;
means for displaying each of said sets of sequential build events;
means associated with each of said displayed sequential build events enabling a user to interactively register to perform an action on said build event; and
means associated with each of said displayed sequential build events enabling a user to interactively unregister to perform an action on said build event.

2. The computer controlled display system of claim 1 wherein said means enabling a user to register to perform an action on a build event further includes:
means for determining whether the user is authorized to perform said action.

3. The computer controlled display system of claim 2 wherein said means enabling a user to register to perform an action on a build event further includes:
means enabling a user to selectively request a displayed data entry dialog box; and
means for determining whether the user is authorized to register from the data entered in said box.

4. The computer controlled display system of claim 1 further including means responsive to a state in a build event for automatically performing a registered action on said build event.

5. The computer controlled display system of claim 1 further including means responsive to a state in a build event for enabling a user to selectively perform a registered action on said build event.

6. The computer controlled display system of claim 1 wherein said registered action is notice to the registered user of a state in a build event.

7. The computer controlled display system of claim 6 wherein another registered action may be selectively performed by the registered user.

8. The computer controlled display system of claim 7 wherein:
the registered user is a manager of the building of a program object;
the state in a build event is a request of another user to register or unregister; and
the selective action performed by said manager is the authorization of the request.

9. The computer controlled display system of claim 1 wherein said means enabling a user to unregister to perform an action on a build event further includes:
means enabling a user to selectively request a displayed data entry dialog box; and
means for determining from the data entered in said box whether the user is authorized to unregister to perform an action.

10. A computer controlled user interactive display system for dynamically tracking and controlling the building of software program objects comprising:
means for tracking a sequence of build events in the building of a program object;
means for displaying each of said sequence build events;
means associated with each of said displayed sequence of build events for enabling a user to selectively request a displayed dialog window including:
a menu of actions said user may selectively perform on the associated build event at the current state of the event; and
data entry means enabling the user to request registration to perform an action on the build event or unregistration to perform an action on the build event.

11. The computer controlled display system of claim 10 further including means for determining whether the requested registration or unregistration is authorized.

12. A method for dynamically tracking and controlling the building of software program objects on a computer controlled user interactive display system comprising:
tracking each of a plurality of sets of sequential build events, each set of sequential build events respectively building a program object;
displaying each of said sets of sequential build events;
enabling a user to interactively register to perform an action on each of said displayed sequential build events; and
enabling a user to interactively unregister to perform an action on each of said displayed sequential build events.

13. The method of claim 12 wherein said step of enabling a user to register to perform an action on a build event further includes:
the step of determining whether the user is authorized to perform said action.

14. The method of claim 13 wherein said step of enabling a user to register to perform an action on a build event further includes the steps of:
enabling a user to selectively request a displayed data entry dialog box; and
determining whether the user is authorized from the data entered in said box.

15. The method of claim 12 further including:
the step of automatically performing a registered action on said build event responsive to a state in a build event.

16. The method of claim 12 further including:
the step of enabling a user to selectively perform a registered action on said build event responsive to a state in a build event.

17. The method of claim 12 wherein said registered action is notice to the registered user of a state in a build event.

18. The method of claim 17 including the step of selectively performing another registered action by said registered user in response to said notice.

19. The method of claim 18 wherein:
said registered user is a manager of the building of a program object;
said state in a build event is a request of another user to register or unregister; and
said selective action performed by said manager is the authorization of the request.

20. The method of claim 12 wherein said means enabling a user to unregister to perform an action on a build event further includes the steps of:
enabling a user to selectively request a displayed data entry dialog box; and
determining from the data entered in said box whether the user is authorized to unregister.

21. A method for dynamically tracking and controlling the building of software program objects on a computer controlled user interactive display system comprising:
tracking each of a plurality of sets of sequential build events, each set of sequential build events respectively building a program object;
displaying each of said sets of sequential build events;
enabling a user to selectively request a displayed dialog window in association with each of said displayed sequence of build events for including:
a menu of actions said user may selectively perform on the associated build event at the current state of the event; and
data entry means enabling the user to request registration to perform an action on the build event or unregistration to perform an action on the build event.

22. The method of claim 21 further including the step of determining whether the requested registration or unregistration is authorized.

23. A computer program having code recorded on a computer readable medium for dynamically tracking and controlling, on a computer controlled display, the building of software program objects, said computer program comprising:
means for tracking each of a plurality of sets of sequential build events, each set of sequential build events respectively building a program object;
means for displaying each of said sets of sequential build events;
means associated with each of said displayed sequential build events enabling a user to interactively register to perform an action on said build event; and
means associated with each of said displayed sequential build events enabling a user to interactively unregister to perform an action on said build event.

24. The computer program of claim 23 wherein said means enabling a user to register to perform an action on a build event further includes:
means for determining whether the user is authorized to perform said action.

25. The computer program of claim 24 wherein said means enabling a user to register to perform an action on a build event further includes:
means enabling a user to selectively request a displayed data entry dialog box; and
means for determining whether the user is authorized to register from the data entered in said box.

26. The computer program of claim 23 further including means responsive to a state in a build event for automatically performing a registered action on said build event.

27. The computer program of claim 23 further including means responsive to a state in a build event for enabling a user to selectively perform a registered action on said build event.

28. The computer program of claim 27 wherein said registered action is notice to the registered user of a state in a build event.

29. The computer program of claim 28 wherein another registered action may be selectively performed by the registered user.

30. The computer program of claim 29 wherein:
the registered user is a manager of the building of a program object;
the state in a build event is a request of another user to register or unregister; and
the selective action performed by said manager is the authorization of the request.

31. The computer program of claim 23 wherein said means enabling a user to unregister to perform an action on a build event further includes:
means enabling a user to selectively request a displayed data entry dialog box; and
means for determining from the data entered in said box whether the user is authorized to unregister to perform an action.

32. A computer program having code recorded on a computer readable medium for dynamically tracking and controlling, on a computer controlled display, the building of software program objects, said computer program comprising:
means for tracking a sequence of build events in the building of a program object;
means for displaying each of said sequence build events;
means associated with each of said displayed sequence of build events for enabling a user to selectively request a displayed dialog window including:
a menu of actions said user may selectively perform on the associated build event at the current state of the event; and
data entry means enabling the user to request registration to perform an action on the build event or unregistration to perform an action on the build event.

33. The computer program of claim 32 further including means for determining whether the requested registration or unregistration is authorized.
